(19) United States
(12) Patent Application Publication
(10) Pub. No.: US 2001/0031681 A1
(43) Pub. Date: Oct. 18, 2001

(54) Method and apparatus for an improved accumulator for transmissions

(76) Inventor: Blaine F. Green, West Valley City, UT (US)

Correspondence Address: Garron M. Hobson, THORPE, NORTH & WESTERN, L.L.P., P.O. Box 1219, Sandy, UT, 84091-1219, US

(21) Appl. No.: 09/760,022

(22) Filed: Jan. 12, 2001

Related U.S. Application Data
(60) Provisional application No. 60/176,335, filed on Jan. 14, 2000.

(51) Int. Cl. F16H 61/30

(52) U.S. Cl. 475/129

(57) ABSTRACT

An accumulator of a transmission, and method of modifying an accumulator, includes a replacement spring. The replacement spring replaces the typical shorter spring of shorter and longer springs biasing a valve in a cylinder of an accumulator valve body. The replacement spring has a length greater than the replaced short spring, but less than or equal to the longer spring. The replacement spring provides a shorter shift duration and a firmer shift.

This application claims the benefit of U.S. Provisional Application No. 60/176,335 filed Jan. 14, 2000.

### BACKGROUND OF THE INVENTION

1. Field of the Invention

The present invention relates to accumulators and transmissions. More particularly, the present invention relates to improving the springs in an accumulator of a transmission to provide a firmer and shorter shift duration.

2. Prior Art

Modern transmissions include an accumulator which accumulates transmission oil from an oil pump until the oil is used by the transmission and/or clutch. Such accumulators include a number of pistons or valves movably disposed in a number of respective cylinders under the biasing force of springs. Transmission oil is pumped from the oil pump, through a pressure regulator valve, into one of the cylinders of the accumulator. The pressure of the transmission oil displaces the valve or piston in the cylinder, and compresses the springs biasing the valve. Thus, the transmission oil and pressure are accumulated until used to shift the transmission.

For example, referring to FIG. 1, a typical accumulator 10 may include first, second and third valves 14, 16 and 18 disposed in respective first, second and third cylinders 22, 24 and 26 in an accumulator valve body 30. The first, second and third valves and cylinders correspond to respective shifts from first to second gears, second to third gears, and third to fourth gears.

Each valve may be biased by two springs, including a first, longer spring 40, and a second, shorter spring 46. The longer spring 40 may bias the valve 14 through its entire length of travel, or have a length L1 extending from a distal end of the cylinder to the valve. The shorter spring 46 biases the valve 14 near the end of the travel of the valve, and has a length L2 less than the length L1 of the longer spring 40. Thus, the pressure of the transmission oil acts initially against only the longer spring 40, and subsequently against both the longer and shorter springs 40 and 46. Such a configuration of the springs provides a longer and softer shift. The springs are typically designed to provide such a soft, or aesthetically pleasing shift. One disadvantage with such accumulator and/or spring configurations is that the longer, softer shift interval wears on the clutch, tending to cause the clutch to burn-out sooner. Another disadvantage with such a configuration is that they are not adjustable or variable, or do not lend themselves to being modified, in accordance with the user's preferences.

Therefore, it would be advantageous to develop an improved accumulator for a transmission which is capable of being modified to the user's preference. It would also be advantageous to develop an improved accumulator for a transmission which increases the shift time and life of the clutch.

### OBJECTS AND SUMMARY OF THE INVENTION

It is an object of the present invention to provide an improved accumulator of a transmission to decrease shift time and prolong clutch life.

It is another object of the present invention to provide a method for modifying the accumulator of a transmission.

These and other objects and advantages of the present invention are realized in an improved accumulator and/or a replacement spring for providing greater resistence or biasing force, and/or a more constant resistence or biasing force, and/or a quicker resistance or biasing force. The accumulator is configured for use with a transmission, such as a vehicle transmission, and includes an accumulator valve body with one or more a cylinders formed therein to receive or accumulate transmission oil. A valve is movably disposed in each cylinder and is moved or displaced under the force or pressure of the transmission oil. The valve has a range of travel generally between a proximal end of the cylinder, and a distal end of the cylinder (or somewhere between the proximal end and distal end).

A first, longer spring may be disposed in each cylinder to bias the at least one valve within the at least one cylinder against the force or pressure of the transmission oil, and against displacement of the valve. The first, longer spring is has a length to act over the entire range of travel of the at least one valve.

The replacement spring also is disposed within the cylinder, and may be dispose in the first spring. The replacement spring also is configured to bias the at least one valve within that at least one cylinder over the entire range of travel of the valve. As stated above, the accumulator typically includes a longer spring and a shorter spring, which provide different resistance along different locations of the path of travel of the valve. The replacement spring replaces the typical shorter spring. The replacement spring provides a shorter shift time and a firmer shift for the transmission. The first, longer spring, and the replacement spring preferably have the same length, to provide a single, continuous biasing force over a length of travel of the valve. The resistance or bias may be adjusted or modified by modifying the length of the replacement spring.

A method for selectively modifying the shift time of a transmission includes first removing a plug from the accumulator valve body. The shorter spring is removed from the cylinder in the accumulator valve body. A third spring or replacement spring is inserted into the cylinder in the accumulator valve body. As stated above, the third or replacement spring has a length greater than a length of the short spring, and less than or equal to a length of the long spring. The plug is replaced on the accumulator valve body.

The shift time of the transmission may be evaluated with respect to a user's preference. If the shift duration is too short, or the shift is too firm, the length of the replacement spring may be modified by again removing the plug from accumulator valve body, removing the third spring from the cylinder, and cutting off one or more coils of the third spring to shorten the third spring so that the third spring is shorter, but longer than the shorter spring. The shortened third spring is reinserted into the cylinder in the accumulator valve body, and the plug replace on the accumulator valve body.

Alternatively, a different replacement spring may be inserted into the cylinder which is longer than the short spring, but shorter than the third spring.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1 is a cross-sectional view of an accumulator of the prior art.

FIG. 2 is an exploded view of an accumulator valve, springs, and plug of the prior art.

FIG. 3 is a cross-sectional view of a preferred embodiment of an accumulator of the present invention.

FIG. 4 is an exploded view of a preferred embodiment of a valve, springs, and plug of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention.

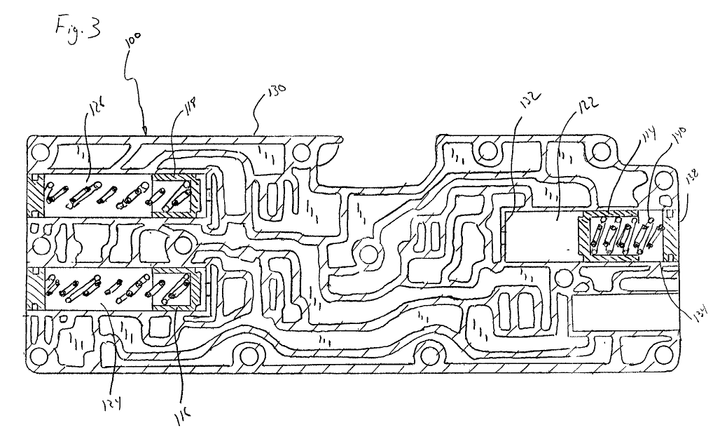

As illustrated in FIGS. 3 and 4, an accumulator, indicated generally at 100 is shown which is configured to be used with a transmission (not shown), such as a vehicle transmission. The accumulator 100 has an accumulator valve body 130 which may be directly attached to the transmission. The accumulator valve body 130 includes passages for allowing for the flow of transmission oil through the valve body 130. As stated above, an oil pump (not shown) pumps transmission oil through a pressure regulator valve (not shown) to the accumulator valve body 130. The accumulator valve body 130 receives or accumulates the transmission oil, which is subsequently used by the transmission, or a clutch of the transmission.

The valve body 130 includes a plurality of cavities or cylinders, including a first cylinder 122, a second cylinder 124, and a third cylinder 126. Each cylinder has a proximal end 132, through which transmission oil is received into the cylinder, and an opposite distal end 134. The distal end 134 of the cavities 122 has an opening in which a plug 138 is removably disposed. A movable piston or valve is movably disposed in each cylinder, including a first valve 114, a second valve 116, and a third valve 118, each disposed in the respective first, second and third cylinders 122, 124 and 126.

The first valve 114 and first cylinder 122 may correspond to a first clutch, or shifting the transmission from a first to a second gear. The second valve 116 and the second cylinder 124 may correspond to a second clutch, or shifting the transmission from a second gear to a third gear. Similarly, the third valve 118 and third cylinder 126 may correspond to a third clutch, or shifting the transmission from a third gear to a fourth gear.

The valves are movably disposed in the cylinders, and move back and forth along a path of travel. The path of travel of the valves includes an initial position or location in which the valve is located near the proximal end 132, as shown by valves 116 and 118. Pressurized transmission oil received through an opening in the proximal end 132 of the cavities causes the valves to displace towards the distal ends 134, as shown by valve 114. Thus, the pressure of the transmission oil and the transmission oil is accumulated in the cylinders.

The valves 114, 116, and 118 are biased in the initial position, or towards the proximal ends 132 of the cavities, to resist displacement of the valves, and the pressure of the transmission oil. A first spring 140 is disposed in each cylinder to bias the valve. Each of the first springs 140 has a length L1 that extends from the distal end 134 of the cavity to the valve in the initial position, such that the first spring 140 acts over the entire length of travel of the valve.

Advantageously, a replacement spring 150 also is disposed in each cylinder to bias the valves. The replacement spring 150 has a length L3, which preferably is equal to the length L1 of the first spring 140. Alternatively, the length L3 of the replacement spring 150 may be less than the length L1 of the first spring 140, but is greater than the length L2 of the second shorter spring 46. Thus, the replacement spring 150 preferably extends from the distal end 134 of the cylinder to the valve in the initial position, such that both the first spring 140 and the replacement spring 150 act over the entire length of travel of the valve.

Because both springs 140 and 150 have the same length, the springs apply a single continuous resistance to the valves. In addition, the replacement spring 150 causes the bias, or the resistance, to displacement of the valves to be greater than merely the first spring 140 by itself. Thus, the resistance provided by both springs 140 and 150 is greater, and acts over the entire length of travel of the valves, resulting in a firmer and shorter shift duration of the transmission.

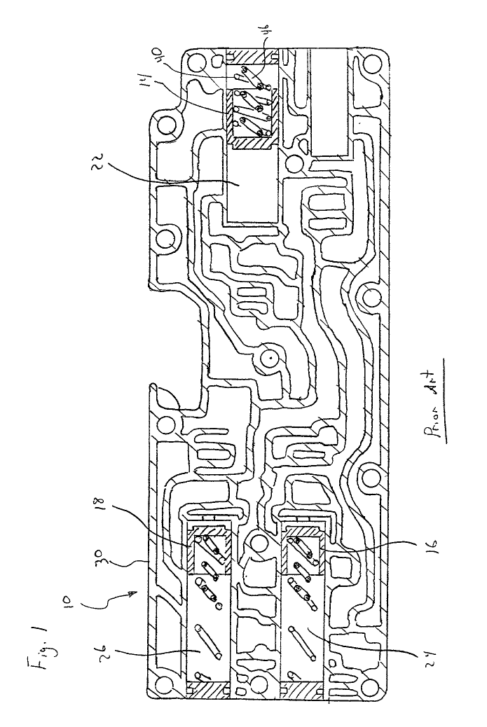

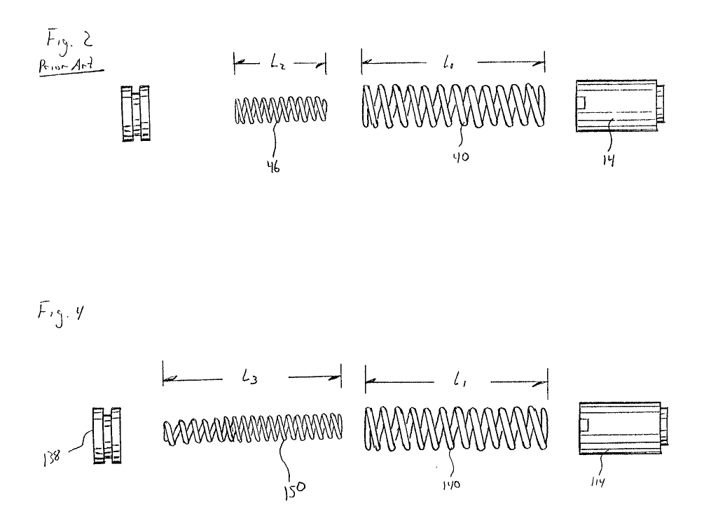

Both the first and second springs 140 and 150 resist displacement of the valve, starting from the initial position of the valve near the proximal end, as shown by valves 116 and 118 in FIG. 3. Thus, both springs 130 and 140 apply resistance to the pressure of the transmission oil, and the accumulation of transmission oil in the cylinders. The prior art accumulators 10 include only the first spring 40 to initially apply resistance to displacement of the valve 14, and pressure of the transmission oil, with the second spring 46 only applying resistance near the end of travel of the valve 14, as shown in FIG. 1. The result of the replacement spring 150 of the present invention, providing a greater resistance and initially applying that resistance, is a shorter shift duration, and a firmer shift, in the transmission. The shorter shift duration helps increase the life of the clutch. In addition, the quicker shift increases the durability of the transmission, especially when under a load, such as during towing with a vehicle.

The replacement spring 150, and/or first spring 140, are examples of biasing means for biasing the valve in the cylinder. It is of course understood that other means for biasing may be used, including for example, a single replacement spring which is stronger or stiffer than the first spring 140 in place of both the replacement spring and first spring, a replacement spring which is shorter than the first spring 140 but still longer than the second spring 46, other flexible and resilient materials or spring configurations, etc.

A method for selectively modifying the shift time of the transmission includes removing the plug 138 from the accumulator valve body 130 (or 30). It may be necessary to remove the valve body 130 from the transmission and to remove a clip or the like retaining the plug 138 in the opening of the cylinder. Any short spring, such as the second, shorter spring 46 is removed from the cylinder 122 (or 22). The shorter spring is replaced by a third, longer spring, such as the replacement spring 150, by inserting the replacement spring 150 into the cylinder 122. The replacement spring 150 may be inserted within the first spring 140. The plug 138 is replaced on the accumulator valve body 130. Again, it may be necessary to replace a clip or the like to retain the plug in the opening of the cylinder, and to replace the valve body 130 on the transmission.

The shift time duration of the transmission then may be evaluated in accordance with the user's preferences. If the shift duration is too short, or the shift too firm, it may be necessary to increase the shift duration, and/or loosen the shift. Modifying the shift duration may be accomplished by shortening the replacement spring 150. The plug 138 is removed from accumulator valve body 130 again. The replacement spring 150 is removed from the cylinder, and its length adjusted by cutting off one or more coils of the replacement spring to shorten the replacement spring 150. The length of the replacement spring 150 is now shorter than before, but still longer than the second, shorter spring 46. The shortened replacement spring 150 is reinserted into the cylinder, and the plug 138 replaced.

Alternatively, the replacement spring 150 may be removed entirely, and replace by a fourth spring having a length which is longer than the short spring, but shorter than the third spring, or replacement spring.

Replacing the second spring 46 with a longer replacement spring 150 to provide two springs 140 and 150 is preferably to a single stiffer spring because a single stiffer spring is more likely to break.

It is to be understood that the described embodiments of the invention are illustrative only, and that modifications thereof may occur to those skilled in the art. Accordingly, this invention is not to be regarded as limited to the embodiments disclosed, but is to be limited only as defined by the appended claims herein.

What is claimed is:

1. An improvement in an accumulator configured to be used with a transmission, the accumulator including: an accumulator valve body; a cylinder, formed in the accumulator valve body, configured to receive transmission oil; and a valve, movably disposed in the cylinder; the improvement comprising:
biasing means, disposed in the cylinder, for biasing the valve in the cylinder.

2. The accumulator of claim 1, wherein the biasing means provides a single, continuous biasing force over a length of travel of the valve.

3. The accumulator of claim 1, wherein the accumulator further includes a first spring, disposed in the cylinder, to bias the valve in the cylinder; and wherein the biasing means includes a second spring, disposed in the cylinder, having a length equal to a length of the first spring.

4. An accumulator configured to be used with a transmission, comprising:
an accumulator valve body having at least one cylinder formed therein;
at least one valve, movably disposed in the at least one cylinder in the accumulator valve body, having a range of travel in the cylinder;
a first spring, disposed in the at least one cylinder in the accumulator valve body, configured to bias the at least one valve within the at least one cylinder over the entire range of travel of the at least one valve; and
a second spring, disposed within the first spring in the at least one cylinder in the accumulator valve body, configured to bias the at least one valve within the at least one cylinder over the entire range of travel of the at least one valve, thereby providing a short and firm shift time for the transmission.

5. The accumulator of claim 4, wherein the at least one cylinder has a proximal end and an opposite distal end; and wherein the at least one valve has an initial location along the path of travel at the proximal end of the cylinder; and wherein the first and second springs extend between the valve and the distal end of the cylinder.

6. A method for selectively modifying the shift time of a transmission having an accumulator valve body with a valve movably disposed in a cylinder biased by a longer spring and a shorter spring, the valve and springs being held within the cylinder by a plug, the method comprising the steps of:
a) removing the plug from the accumulator valve body;
b) removing at least the shorter spring from the cylinder in the accumulator valve body;
c) inserting a third spring into the cylinder in the accumulator valve body, the third spring having a length greater than a length of the short spring, and less than or equal to a length of the long spring; and
d) replacing the plug on the accumulator valve body.

7. The method of claim 6, further comprising the steps of:
a) evaluating the shift time of the transmission;
b) removing the plug from accumulator valve body;
c) removing the third spring from the cylinder of the accumulator valve body;
d) adjusting the length of the third spring by cutting off one or more coils of the third spring to shorten the third spring so that the third spring is shorter, but longer than the shorter spring;
e) reinserting the shortened third spring into the cylinder in the accumulator valve body; and
f) replacing the plug on the accumulator valve body.

8. The method of claim 6, further comprising the steps of:
a) evaluating the shift time of the transmission;
b) removing the plug from accumulator valve body;
c) removing the third spring from the cylinder of the accumulator valve body;
d) inserting a fourth spring into the cylinder of the accumulator valve body, the forth spring having a length which is longer than the short spring, but shorter than the third spring;
e) replacing the plug on the accumulator valve body.
